(19) United States
(12) Patent Application Publication
(10) Pub. No.: US 2007/0266692 A1
(43) Pub. Date: Nov. 22, 2007

(54) MULTI-PRONG CONVERSION TINE FOR A HARVESTER REEL

(76) Inventor: David R. Lolley, Bettendorf, IA (US)

Correspondence Address: TAYLOR & AUST, P.C., P.O. Box 560, 142. S Main Street, Avilla, IN, 46710, US

(21) Appl. No.: 11/744,437

(22) Filed: May 4, 2007

Related U.S. Application Data
(60) Provisional application No. 60/801,322, filed on May 18, 2006.

(51) Int. Cl. A01D 89/00

(52) U.S. Cl. 56/364

(57) ABSTRACT

An agricultural harvester includes a harvester reel with a plurality of pickup tines spaced along a length thereof, and at least one conversion tine. Each conversion tine includes an elongate hollow body having a cavity with an open proximal end. The hollow body is positioned over the pickup tine such that the pickup tine extends through the proximal end and is received within the cavity. At least one fastener adjacent the proximal end fastens the hollow body over the pickup tine. At least one lateral extension extends from the hollow body in a lateral direction along the length of the harvester reel.

### CROSS REFERENCE TO RELATED APPLICATIONS

This is a non-provisional application based upon U.S. provisional patent application Ser. No. 60/801,322, entitled “MULTI-PRONG FINGER FOR A HARVESTER REEL”, filed May 18, 2006.

### FIELD OF THE INVENTION

The present invention is directed to pickup tines for a harvester reel on an agricultural harvester.

### BACKGROUND OF THE INVENTION

Combines used in the harvesting for example of wheat, soy beans and small grains typically have a rotating cylindrical harvester reel at the forward leading edge of the cutting platform to sweep the crop which is to be harvested into the combine apparatus. These reels include a plurality of spaced horizontally extending support shafts which rotate with the reel and which have a plurality of pickup tines attached in side by side relationship to each other along the length of the support shafts. These pickup tines are typically molded in one piece integral construction of a durable plastic, such as for example, nylon, acetal or homopolypropylene, and include a clamp for clamping the pickup tine to the support shaft and an elongate curved finger of approximately 7½ inches long which extends from the clamp so as to sweep the crop to be harvested into the harvester reel and combine. These curved fingers can become ineffective due to breakage or accidental cutting of the fingers due to operator error in running the reel too close to the cutterbar.

Once a sufficient number of tine fingers have been broken to impair the efficient operation of the harvester reel, it is necessary to stop the harvester and manually unscrew and remove the broken pickup tines from the support shaft and replace them with new tines. This obviously is wasteful of both time and effort and minimizes the time which the combine is in service.

Under certain operating conditions, a conventional pickup tine as described above will not adequately pick up the crop material, regardless of whether the tine is an original or repair tine. For example, when a crop harvester equipped with a front mounted cutter bar is cutting in conditions that accumulate crop and other material on the cutter bar, sufficient amounts can build up on the cutter bar to limit the ability of the pickup tines to pull the material into the machine because the strength or rigidity of the finger's cross section is exceeded. This condition eventually forces the operator of the machine to stop and clean it off, or slow to a speed that allows the reel to make multiple passes to clear the material. As another example, when a crop harvester is in extremely short crop, a conventional pickup tine does not contact enough of the plant to adequately pull it into the cutter bar.

An example of a tine for a harvester reel that can be used to repair an existing broken pickup tine is disclosed in U.S. Patent Application Publication No. 2007/0028580 (Glazik et al., '580 publication). In the '580 publication, a repair tine includes a hollow finger with an open proximal end and a closed distal end. The hollow finger is slid over the broken pickup tine. A snap fit arrangement at the proximal end of the hollow finger snap fits with the pickup tine to hold the repair tine in place. This type of repair tine arrangement reduces down time in the field by allowing a single broken pickup tine to be quickly repaired to place the combine back in operation. Since the repair tine includes a single finger, it does not help with moving the crop to and over the cutterbar under short or light crop conditions.

What is needed in the art is a tine for a harvester reel that can be used to convert or repair a conventional pickup tine to one that is more adaptable for use in adverse conditions as described above.

### SUMMARY OF THE INVENTION

The present invention substantially reduces such waste of time, effort and downtime by permitting a tine finger to be easily and rapidly converted or repaired without the need to remove the pickup tine from the support shaft and replace it with a new tine. In the present invention, a multi-prong finger includes a hollow body which is simply slipped over the pickup tine and is fastened in place to the existing tine without the need to remove the existing tine from the support shaft. Moreover, if the hollow finger itself subsequently becomes broken, it may easily be replaced simply by removing it from the preexisting pickup tine and replacing the hollow finger with a new hollow finger. A pair of prongs are coupled with, positioned laterally from, and extend generally parallel to the hollow finger.

The invention in one form is directed to an agricultural harvester including a harvester reel with a plurality of pickup tines spaced along a length thereof, and at least one conversion tine. Each conversion tine includes an elongate hollow body having a cavity with an open proximal end. The hollow body is positioned over the pickup tine such that the pickup tine extends through the proximal end and is received within the cavity. At least one fastener adjacent the proximal end fastens the hollow body over the pickup tine. At least one lateral extension extends from the hollow body in a lateral direction along the length of the harvester reel.

### BRIEF DESCRIPTION OF THE DRAWINGS

FIG. 1 is a perspective view of a harvester reel with pickup tines shown mounted on the front of a harvester combine;

FIG. 2 is a fragmentary, perspective, enlarged view of one of the support shafts of the harvester reel substantially as shown in FIG. 1, and upon which three pickup tines are mounted, one of which has been broken;

FIG. 3 is a partially broken side elevation view of the broken pickup tine as shown in FIG. 2;

FIG. 4 is a partially fragmentary, perspective view of an embodiment of a conversion tine of the present invention;

FIG. 5 is a partially sectioned, perspective view of the conversion tine shown in FIG. 4; and

FIGS. 6-9 are perspective views of alternative embodiments of conversion tines of the present invention.

### DETAILED DESCRIPTION OF THE INVENTION

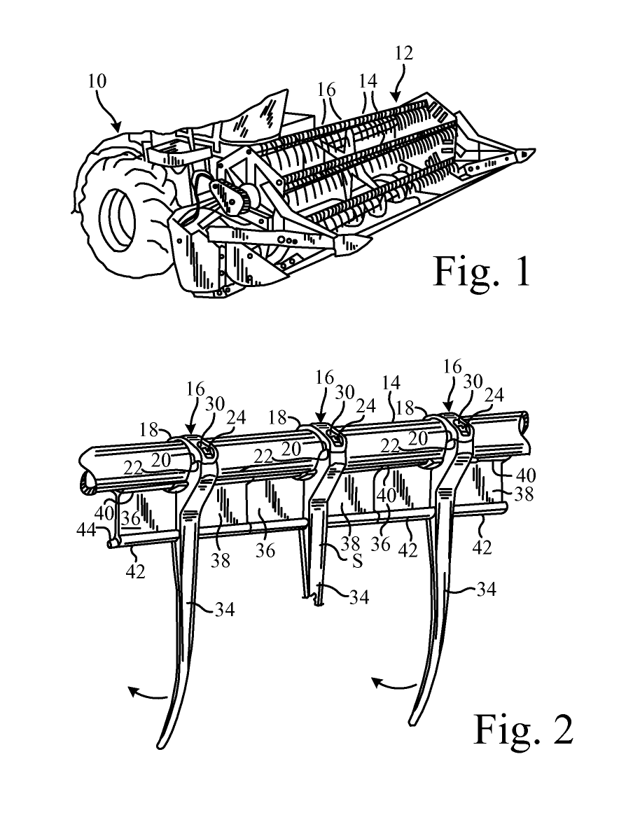

Referring now to FIGS. 1 and 2, an agricultural harvester in the form of a combine 10 for harvesting a crop includes a harvester reel 12 at the forward end thereof for picking up the crop to be harvested for processing by the combine. Such crops typically include wheat, soybeans and other small grains. The harvester reel 12 includes a plurality of horizontally extending spaced apart support shafts 14 which rotate as the reel 12 is rotated. Each of the support shafts 14 has a plurality of pickup tines 16 spaced at approximately equal distances from each other along the length of each support shaft 14.

Although the agricultural harvester is shown in the form of a combine 10 in FIG. 1, it is to be understood that other types of agricultural harvesters may include a harvester reel 12, such as a windrower or haybine, and are likewise within the scope of this invention.

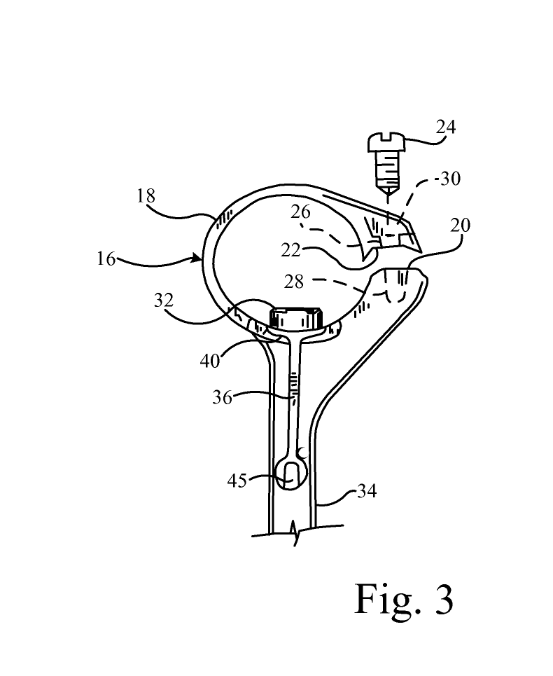

Referring to FIGS. 2 and 3, each of the pickup tines 16 includes a clamp 18 at one end which is preferably formed by a split ring which may be opened by flexing to present a pair of jaws 20 and 22, which may be further flexed to separate from each other to permit passage of the clamp 18 onto and around the support shaft 14. Once the clamp 18 has been positioned on the support shaft 14, the jaws 20 and 22 may be drawn together by the threading of a screw 24 through a hole 26 in the jaw 20 and into a threaded hole 28 in the jaw 22 to draw the split rings into clamping arrangement with the support shaft 14. The clamp 18 also preferably includes a recess 30 to accommodate and protect the head of the screw 24 in use.

The clamp 18 of the pickup tine 16 also preferably includes an upwardly extending projection 32, which fits into an opening (not shown) in the support shaft 14 to ensure that the pickup tine 16 does not rotate relative to the support shaft 14 when in use.

The pickup tine 16 also includes an elongate curved finger 34 which extends downwardly from the clamp 18 to produce the crop gathering and pickup effect for which the harvester reel is provided as the fingers are rotated with the reel, as shown by the arrows in FIG. 2. The finger 34 is typically solid in cross section. The length of the finger 34 is typically between about 7 and 8 inches. It will be appreciated that the length of the finger may vary without departing from the principles of the invention.

The pickup tine 16 may also include one or more wings 36, 38 which extend at an angle to the finger 34 and in a direction generally parallel to the support shaft 14. Wings 36, 38 also preferably include stiffeners 40, 42 which extend along the edges of the wings in order to strengthen the wings 36, 38. The upper stiffener 40 is formed in a generally concave shape to accommodate the curvature of the support shaft 14, and the lower stiffener 42 is generally cylindrical in shape. It will be appreciated, however, that the stiffeners 40 and 42 may assume different shapes without departing from the principles of the invention. The stiffener 42 at one side of the pickup tine 16 may also include a projection 44 which fits upwardly into a downwardly facing slot 45 in the other wing of the next adjacent pickup tine to interlock adjacent pickup tines together along the length of the support shaft 14.

The entire pickup tine 16 including its clamp 18, finger 34 and wings 36, 38 may be formed in one-piece integral form by molding from a suitable material, such as for example, nylon, acetal or homopolyproplylene.

The pickup tine 16 thus far described is conventional and known in the art. The difficulty with such pickup tines is that they are fixed in position along the support shaft and are difficult to reposition. First, the wings 36, 38 abut one another, preventing the tines from being moved inwardly into a closer spacing without completely removing the tines 16 and replacing them with tines 16 having shorter wings. This process of removal is slow and time consuming due to the necessity of unscrewing each of the tines from the supports and then screwing on a replacement tine in its place. This re-spacing process is both time consuming and labor intensive and can result in considerable downtime for the combine.

According to an aspect of the present invention, a pickup tine 16 which is to be converted and/or has broken its finger 34 may be rapidly and easily modified using a conversion tine 46 without removing the pickup tine from the support shaft. The phrase “conversion tine”, as used herein, is a descriptive phrase of convenience intended to designate a primary function of conversion tine 46; namely, to convert a pickup tine 16 to a wider lateral profile to assist in moving crop material to and over the cutterbar. However, it is to be understood that conversion tine 46 can also be used to repair a pickup tine 16 with a broken finger 34.

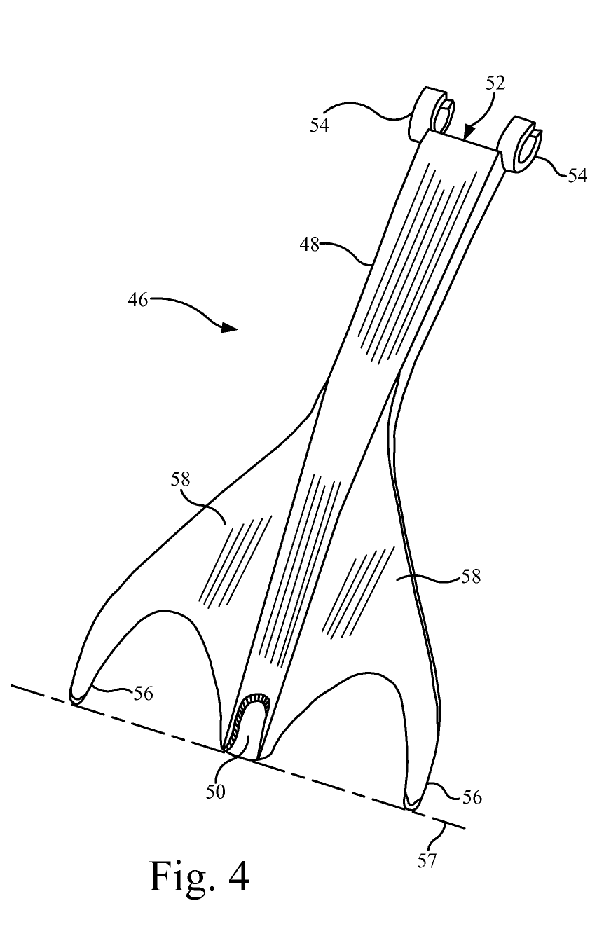

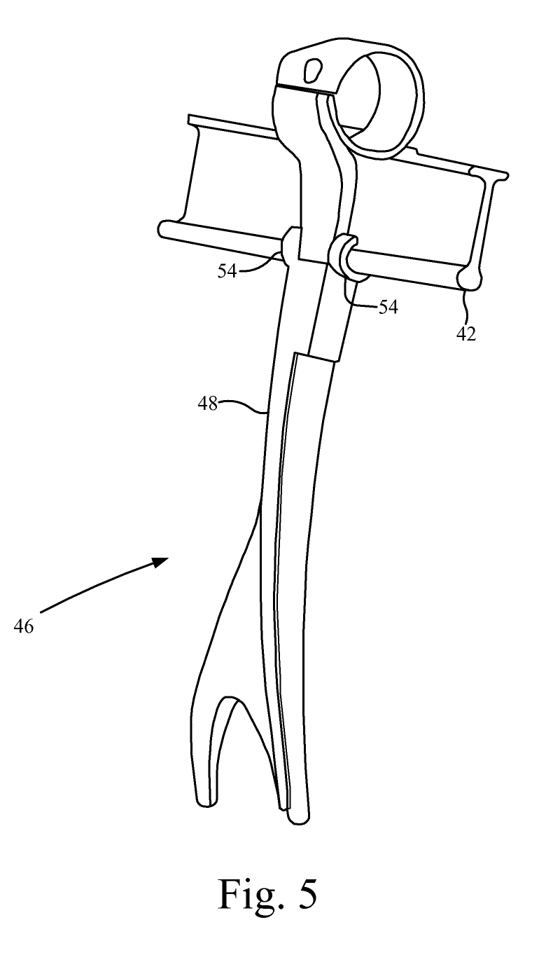

Referring to FIGS. 4 and 5, a conversion tine 46 is used for conversion or repair of tine 16. Conversion tine 46 includes a central elongate curved hollow body 48 which is of the same general shape and size as the original pickup tine finger 34, and which preferably is formed of the same material, but may be formed of a different material. The hollow body 48 has a cavity 50 which extends over substantially the entire length thereof, and which is constructed and arranged to receive finger 34, as shown in FIG. 5, which is inserted into opening 52 at the top end of body 48 to receive all or substantially the entire length of pickup tine 16. Hollow body 48 may include an open end opposite from opening 52 through which tine 34 may extend, depending upon the length of tine 34.

A pair of fasteners with a snap fit arrangement including split rings 54 straddle the opening 52 and frictionally engage the stiffener 42 by snap fit when the body 48 has been finally positioned on the pickup tine 16 to fasten the body 48 to the pickup tine 16. Other types of fastener arrangements are also possible. Additionally, although original finger 34 and hollow body 48 are disclosed as tapering to a smaller cross sectional dimension toward their distal ends, it will be appreciated that they may be of unchanging, flaring or increasing cross sectional dimension over their length without departing from the present invention. Whatever their cross sectional shape or dimension over their length, it is generally preferred that the shape of the original tine is substantially replicated by the body 48 to the extent possible.

A pair of prongs 56, at least 2 in number, extend laterally to the side of hollow body 48. Prongs 56 may also extend to a point up to but not beyond adjacent body 48 when assembled to the reel, and extend downward to approximately the length of body 48. Prongs 56 have respective distal ends which lie generally along a common line 57 passing through the distal end of hollow body 48, but could possibly be offset or staggered if desired. Prongs 56 are shown as being equidistantly spaced on either side of hollow tine 48, but could even be spaced at different distances from hollow tine 48, depending upon the application. In the embodiment shown in FIGS. 4 and 5, prongs 56 extend from a web or paddle 58 that can originate anywhere along hollow tine 48, depending upon the application. Prongs 56 and web 58 are preferably made from the same material as hollow tine 48, and integrally formed therewith.

If conversion tine 46 is ever broken, all that need be done is to disengage it from the pickup tine 16 by pulling downward on conversion tine 46, which applies pressure to unsnap and remove the split rings 54 from the stiffeners 42, and replace the broken conversion tine 46 with a new unbroken conversion tine 46 by sliding it upward on finger 34 of pickup tine 16 until split rings 54 are flexed outward and snap back into place.

Conversion tine 46 provides more complete lateral coverage of the reel's span along the length of a cutter bar by partially or completely filling the gaps between the existing or original fingers. This helps in two conditions. 1) When material builds up on top of the cutter bar due to taking in large amounts of crop and or soil, the stronger conversion tine 46 can pierce the material and bring it into the machine rather than flexing or breaking. Conversion tine 46 contacts a larger portion of the material which also assists in this regard. 2) When harvesting short crops, conversion tine 46 contacts more of the crop at a point closer to the plant base. This allows the reel to sweep the material back to the cutter bar.

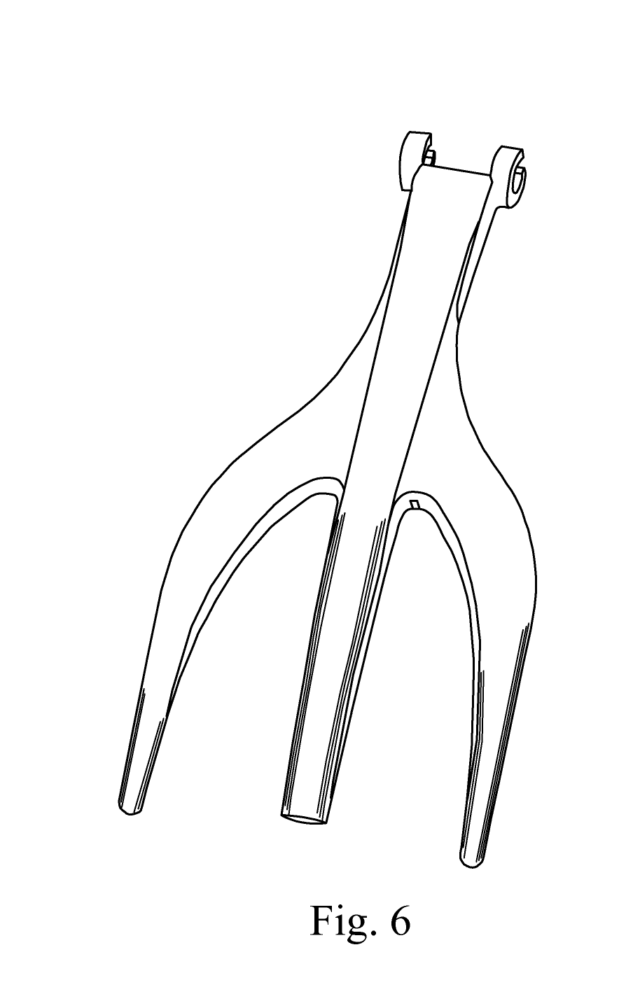

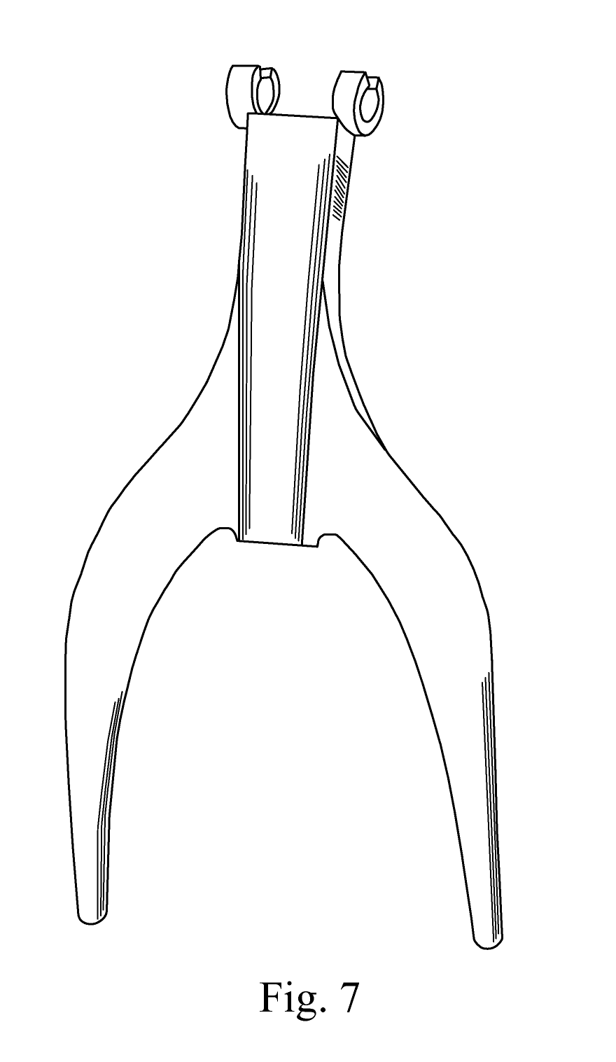

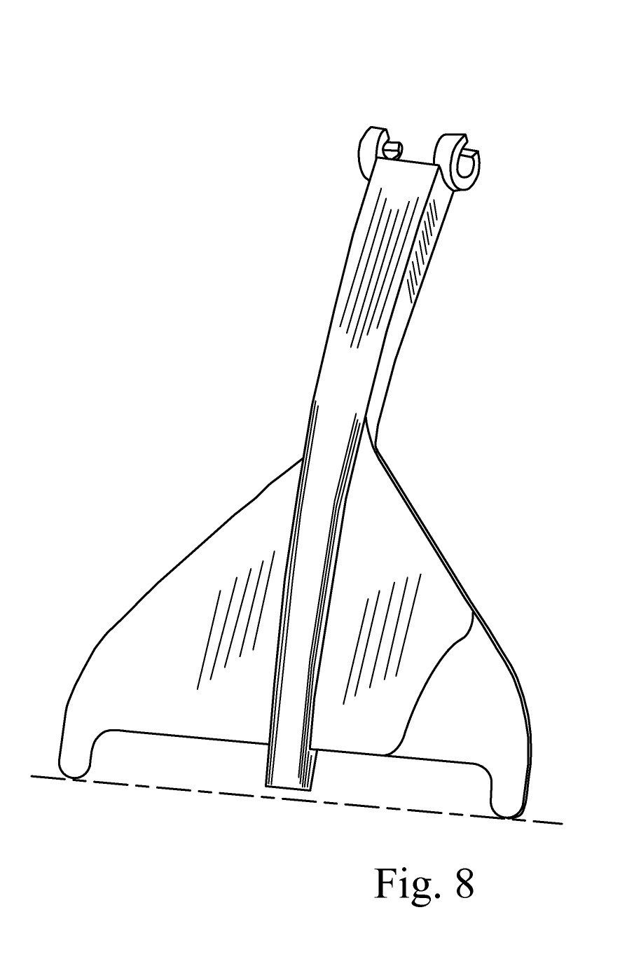

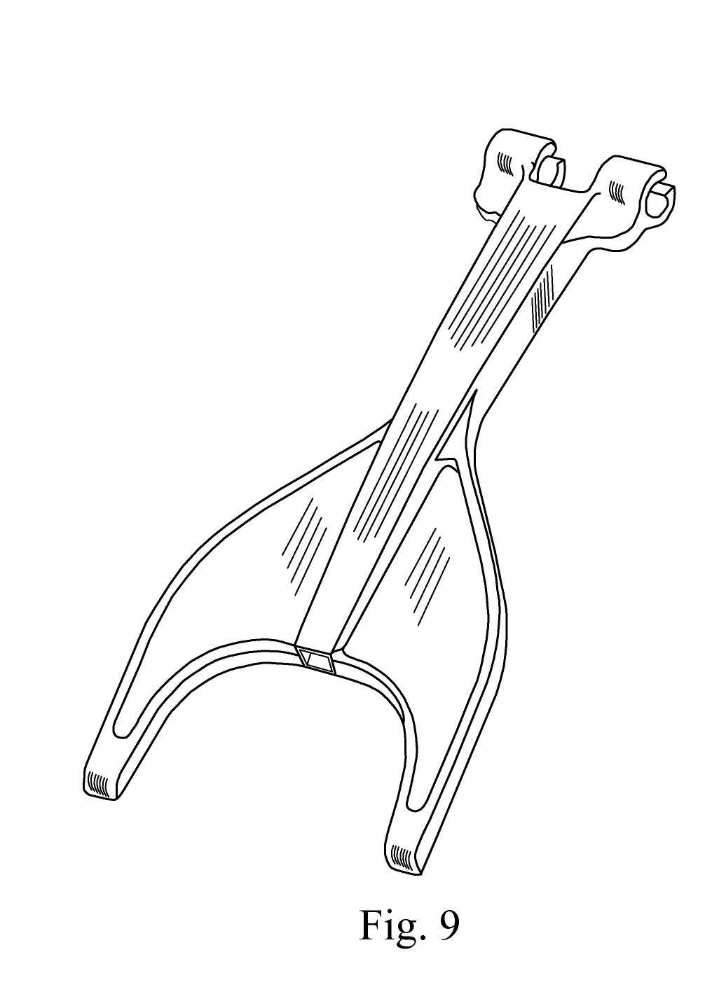

FIGS. 6-9 illustrate other embodiments of a conversion tine of the present invention for conversion or repair of an existing tine on a reel of a harvester. The general construction, installation, removal and operation are similar to the embodiment of conversion tine 46 shown in FIGS. 4 and 5, and thus will be readily understood. In FIG. 6, the hollow body has an open distal end, and the distal ends of the two prongs extend slightly past the distal end of the hollow body. In FIG. 7, the hollow body has a shorter length with an open distal end, and the distal ends of the two prongs extend considerably past the distal end of the hollow body. In FIG. 8, the hollow body has an open distal end, and the two lateral extensions are in the form of a pair of paddles, each defining a lateral prong which extends slightly past the distal end of the hollow body. In FIG. 9, the hollow body has a shorter length with an open distal end, and the distal ends of the two prongs extend considerably past the distal end of the hollow body, with the split rings at the top having a wider profile for rigidity, and stiffening ribs on the lateral webs for rigidity.

Having described the preferred embodiment, it will become apparent that various modifications can be made without departing from the scope of the invention.

What is claimed is:

1. An agricultural harvester, comprising:
a harvester reel including a plurality of pickup tines spaced along a length thereof; and
at least one conversion tine, each said conversion tine including:
an elongate hollow body having a cavity with an open proximal end, said hollow body positioned over said pickup tine such that said pickup tine extends through said proximal end and is received within said cavity;
at least one fastener adjacent said proximal end for fastening said hollow body over said pickup tine; and
at least one lateral extension, each said lateral extension extending from said hollow body in a lateral direction along said length of said harvester reel.

2. The agricultural harvester of claim 1, wherein each said lateral extension includes a prong spaced apart from said hollow body in said lateral direction.

3. The agricultural harvester of claim 2, wherein each said lateral extension includes a web extending between said prong and said hollow body.

4. The agricultural harvester of claim 2, wherein each said conversion tine includes a pair of lateral extensions.

5. The agricultural harvester of claim 4, wherein said prongs are equidistantly spaced from said hollow body.

6. The agricultural harvester of claim 4, wherein said prongs are integrally formed with said hollow body.

7. The agricultural harvester of claim 4, wherein each said prong extends generally parallel to said hollow body.

8. The agricultural harvester of claim 4, wherein a distal end of said hollow body and a distal end of each said prong lie generally along a common line.

9. The agricultural harvester of claim 1, wherein said hollow body has an open distal end.

10. The agricultural harvester of claim 1, wherein said at least one fastener includes a pair of snap on fasteners.

11. A conversion tine for use with a pickup tine on a harvester reel of an agricultural harvester, said conversion tine comprising:
an elongate hollow body having a cavity with an open proximal end, said hollow body configured for being positioned over a pickup tine such that the pickup tine extends through said proximal end and is received within said cavity;
at least one fastener adjacent said proximal end for fastening said hollow body over the pickup tine; and
at least one lateral extension extending from said hollow body.

12. The conversion tine of claim 11, wherein each said lateral extension includes a prong spaced apart from said hollow body.

13. The conversion tine of claim 12, wherein each said lateral extension includes a web extending between said prong and said hollow body.

14. The conversion tine of claim 12, wherein said at least one lateral extension includes a pair of lateral extensions.

15. The conversion tine of claim 14, wherein said prongs are equidistantly spaced from said hollow body.

16. The conversion tine of claim 14, wherein said prongs are integrally formed with said hollow body.

17. The conversion tine of claim 14, wherein each said prong extends generally parallel to said hollow body.

18. The conversion tine of claim 14, wherein a distal end of said hollow body and a distal end of each said prong lie generally along a common line.

19. The conversion tine of claim 11, wherein said hollow body has an open distal end.

20. The conversion tine of claim 11, wherein said at least one fastener includes a pair of snap on fasteners.

21. A harvester reel tine, comprising:
an elongate hollow body having a cavity with an open proximal end, the cavity being structured and arranged to receive at least a portion of an other harvester reel tine therein,
at least one fastener adjacent said proximal end for fastening the hollow body over said other tine; and
a plurality of prongs, each said prong coupled with and spaced apart laterally from said hollow body.

22. The harvester reel tine of claim 21, wherein said tine includes a web extending between said hollow body and a corresponding said prong.

23. The harvester reel tine of claim 21, wherein each said tine includes a pair of prongs.

24. The harvester reel tine of claim 23, wherein said prongs are equidistantly spaced from said hollow body.

25. The harvester reel tine of claim 24, wherein said prongs are integrally formed with said hollow body.

26. The harvester reel tine of claim 24, wherein each said prong extends generally parallel to said hollow body.

27. The harvester reel tine of claim 23, wherein a distal end of said hollow body and a distal end of each said prong lie generally along a common line.

28. The harvester reel tine of claim 21, wherein said hollow body has an open distal end.

29. The harvester reel tine of claim 21, wherein said at least one fastener includes a pair of snap on fasteners.
